(19) United States
(12) Patent Application Publication
(10) Pub. No.: US 2017/0001344 A1
(43) Pub. Date: Jan. 5, 2017

(54) METHOD TO DECREASE THE ACETALDEHYDE AND FORMALDEHYDE CONTENT IN THE CELLULOSIC FIBER-REINFORCED POLYPROPYLENE COMPOSITES THERMOPLASTICS

(71) Applicant: Magna International Inc., Aurora (CA)

(72) Inventors: Alexis Baltazar-y-Jimenez, Newmarket (CA); Richard J. Witkowski, Churchill (CA)

(21) Appl. No.: 15/196,843

(22) Filed: Jun. 29, 2016

Related U.S. Application Data
(60) Provisional application No. 62/188,146, filed on Jul. 2, 2015.

(51) Int. Cl. B29C 45/00; B29B 7/94; C08L 23/12; B29C 45/18

(52) U.S. Cl. CPC B29C 45/0001; B29C 45/0005; B29C 45/18; B29B 7/94; C08L 23/12; B29C 2045/0091; B29K 2201/00

(57) ABSTRACT

A method of reducing aldehyde emissions during injection molding of a part with a cellulosic fiber-reinforced polypropylene composition. An injection molding machine capable of the parameters necessary for injection molding of a cellulosic fiber-reinforced polypropylene composition is provided. Said injection molding machine including: a hopper for holding of a pelletized cellulosic fiber-reinforced polypropylene composition material; a feed throat portion; and, a mixing chamber installed in line with the injection molding machine between the hopper and the feed throat portion. Metering an effective amount of an aldehyde reducing composition into the mixing chamber containing pelletized cellulosic fiber-reinforced polypropylene composition and mixing the pelletized cellulosic fiber-reinforced polypropylene composition with the aldehyde reducing composition for wetting the surface of the pellets with the aldehyde reducing composition. A part is then injection molded with the wetted pelletized mixture.

### CROSS-REFERENCE TO RELATED APPLICATIONS

This application claims the benefit of U.S. Provisional Application No. 62/188,146, filed Jul. 2, 2015. The disclosure of the above application is incorporated herein by reference.

### FIELD OF THE INVENTION

The present invention relates to reducing aldehyde emissions during injection molding of cellulosic fiber-reinforced polypropylene compositions.

### BACKGROUND OF THE INVENTION

Volatile organic compound (VOC) emissions are caused by low molecular weight compounds. For example, residual monomers from polymerization, additives, plasticizers, degradation byproducts from processing and aging of a molded part. It is of particular importance to avoid VOC emissions in high value-added bioproducts, particularly for automotive applications. Cellulosic and lignocellulosic materials, such as wood, flax, hemp, sisal, abaca and coir may be used as reinforcement in polypropylene because of their lower density and cost. Nevertheless, exposing cellulose-based materials to thermal oxidative degradation, for example, from drying, compounding and molding operations, results in a drastic increase in the acetaldehyde and formaldehyde content in the end part.

Acetaldehyde and formaldehyde are harmful. Its content in automotive end parts is regulated by existing legislation in important jurisdictions including the European Union (1999/13/EC), the United States (EPA), Canada (CEPA) and Japan (JAMA). Original equipment manufacturers (OEMs) have also set strict VOC limits to qualify and deploy new materials into new vehicles that are dependent on part location and market region.

Therefore, it is a goal in the art to decrease the content of acetaldehyde and formaldehyde that is generated during the injection molding of cellulosic-fiber reinforced polypropylene composites to meet automotive requirements on VOC emissions. It is also desirable in the art to decrease acetaldehyde and formaldehyde content in polypropylene parts reinforced with vegetal fibers, including those from: hardwoods, softwoods, roots, husks, fruits, seeds, grasses, reeds, basts, stalks, canes, leafs and leaf sheaths.

### SUMMARY OF THE INVENTION

A method of reducing aldehyde emissions during injection molding of a part with a cellulosic fiber-reinforced polypropylene composition is provided. The method includes providing an injection molding machine capable of the parameters necessary for injection molding of a cellulosic fiber-reinforced polypropylene composition. The injection molding machine includes a hopper for holding of a pelletized cellulosic fiber-reinforced polypropylene composition material. The injection molding machine includes a feed throat portion and also a mixing chamber installed in line with the injection molding machine between the hopper and the feed throat portion. An effective amount of an aldehyde reducing composition is metered into the mixing chamber containing pelletized cellulosic fiber-reinforced polypropylene composition. In the mixing chamber the pelletized cellulosic fiber-reinforced polypropylene composition is mixed with the aldehyde reducing composition for wetting the surface of the pellets with the aldehyde reducing composition. Thereafter, a part is injection molded with the wetted pelletized mixture.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, wherein:

FIG. 1 is a perspective view of an injection molding machine in accordance with the teachings of the present invention.

### DETAILED DESCRIPTION OF THE PREFERRED EMBODIMENTS

The following description of the preferred embodiment(s) is merely exemplary in nature and is in no way intended to limit the invention, its application, or uses.

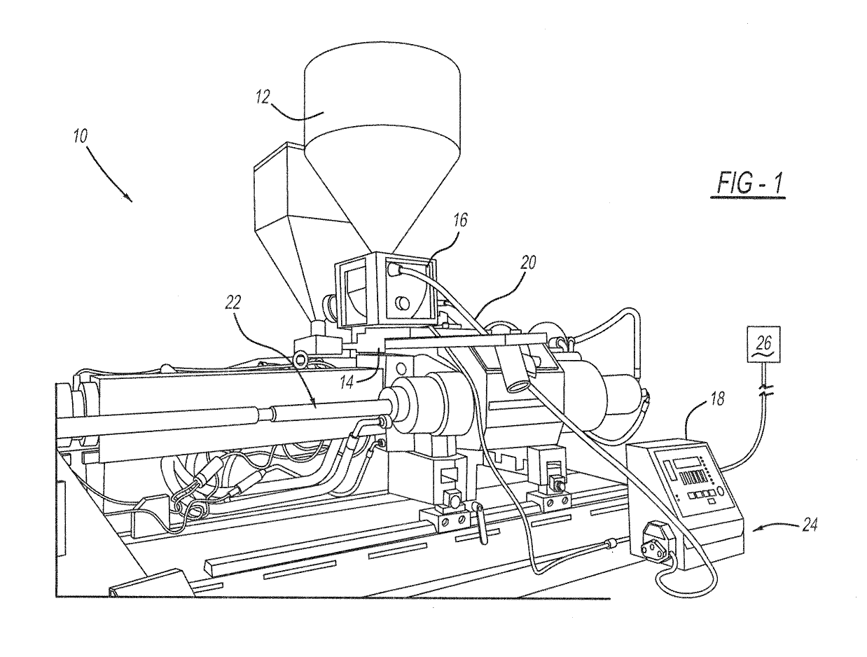

Referring to FIG. 1 generally, in accordance with the present invention there is provided a method of reducing aldehyde emissions during injection molding of a part with a cellulosic fiber-reinforced polypropylene composition comprising the steps of providing an injection molding machine general shown at 10 capable of the parameters necessary for injection molding of a cellulosic fiber-reinforced polypropylene composition. The injection molding machine 10 includes a hopper 12 for holding a pelletized cellulosic fiber-reinforced polypropylene composition material and a feed throat portion 14. The injection molding machine 10 includes a mixing chamber 16 installed in line in the injection molding machine 10 between the hopper 12 and the feed throat portion 14. A predetermined effective amount of an aldehyde reducing composition is metered into the mixing chamber 16 containing pelletized cellulosic fiber-reinforced polypropylene composition by way of a peristaltic pump 18 and a hose 20 which is connected for injecting the aldehyde reducing composition into the mixing chamber 16. Thereafter the pelletized cellulosic fiber-reinforced polypropylene composition is operably mixed in the mixing chamber 16 with the aldehyde reducing composition for wetting the surface the pellets with the aldehyde reducing composition prior to injection molding of a part. Once the pellets are wetted, injection molding of a part with the wetted pelletized mixture through the injection molding machine barrel shown generally at 22 is accomplished. Any positive displacement pump or other types of pumps are contemplated without departing from the scope of the present invention.

As set forth above the injection molding machine 10 of the present invention is preferably of a type which can operate in the narrow processing window of injection molding of cellulosic fiber-reinforced polypropylene composition materials. Such cellulosic fiber-reinforced polypropylene composition materials are used to make polypropylene automotive parts. The polypropylenes used in these parts are often reinforced with vegetal fibers, including those from: hardwoods, softwoods, roots, husks, fruits, seeds, grasses, reeds, basts, stalks, canes, leafs and leaf sheaths and therefore the injection molding machine 10 of the present invention is adapted and the parameters are controlled for specific use with these types of materials.

In the present invention the mixing chamber 16 is used to mix the pelletized polypropylene with the aldehyde reduction composition. The mixing chamber 16 provides agitation of the mixture either by mechanical means or by air pressure or the like to ensure the entire surface of the pellets is wetted by the mixture.

The peristaltic pump 18 is operably connected to a liquid additive reservoir, e.g., such as the reservoir indicated generally at 24, containing the aldehyde reducing composition and feeds the aldehyde reducing composition into the mixing chamber 16 installed on the feed throat 14 of the injection molding machine 10 via the hose 20. An off-relay timer, e.g., timer, control unit or the like connected wirelessly, hard wired, or incorporated into the pump 18, sends a control signal to the peristaltic pump 18 to feed a predetermined amount of the aldehyde reducing composition during the injection molding cycle, such as during the recovery time of the injection molding cycle. The aldehyde reducing composition is fed inside the mixing chamber 16 thereby wetting the pre-compounded cellulosic fiber-polypropylene pellets.

The present invention at least significantly reduces, and preferably eliminates, aldehyde content such as acetaldehyde and formaldehyde.

With respect to the aldehyde reducer or “scavenger composition” or “liquid additive scavenger”, an anthranilamide, an anthranilamide derivative 1,8 diaminonaphthalene, or 3,4-diaminobenzoic acid and/or mixtures of these is used to form a condensation reaction with any aldehydes which are present and released during melt processing. The product of this reaction is to form an organic compound and water. This binds the free acetaldehyde and formaldehyde compositions. Thus, the process dramatically reduces aldehyde-based VOC emissions during injection molding of automotive parts for vehicles. Examples of such an additive is a ColorMatrix™ “Triple A™” liquid additive and formulations: typically 180-30609-1, 180-30610-1 and particularly 180-30611-1 also available through ColorMatrix Corporation, Cleveland, Ohio.

In one embodiment the aldehyde reducing composition is formed by at least two thermally stable moieties where at least one of the moieties is anthranilamide, an anthranilamide derivative 1,8 diaminonaphthalene, or 3,4-diaminobenzoic acid. Each moiety is reactive with the free acetaldehyde and formaldehyde released of the cellulosic fiber-reinforced polypropylene melt to produce an organic compound and water, thereby binding the free acetaldehyde and formaldehyde and preventing them from being released.

The above aldehyde reducing compositions are metered into the mixing chamber 16 in effective amounts such that a low percent is found in the end part, generally not more than 1.0 weight percent, typically between 0.21 and 0.525 or 0.15 and 0.375, preferably between 0.15 and 0.525 weight percent is found in the end part. It has been found that such amounts provided predetermined desired reduced VOCs which meet the stringent requirements imposed in automotive manufacturing. The above aldehyde reducing compositions are a non-hazardous, non-toxic, effective acetaldehyde and formaldehyde scavengers that works efficiently in the narrow processing window of cellulose-based materials. The above aldehyde reducing compositions also do not have negative effects on the mechanical performance, surface color and odor of the resulting composite.

The method for decreasing aldehyde content, e.g., acetaldehyde and formaldehyde, in injection molded cellulosic fiber-reinforced polypropylene composites for automotive applications using the above aldehyde reducing compositions typically forms a condensation reaction during melt processing to form an organic compound and water.

The equations below, for example, illustrate condensation reactions between the aldehyde reducing composition and the acetaldehyde and formaldehyde formed during the melt processing of cellulosic fiber-reinforced polypropylene during injection molding.

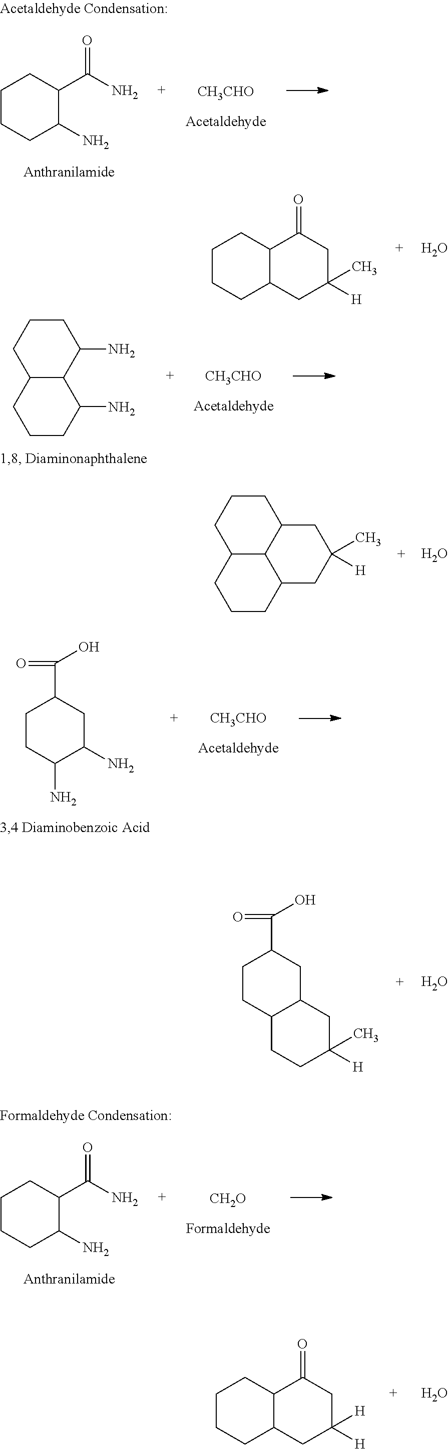

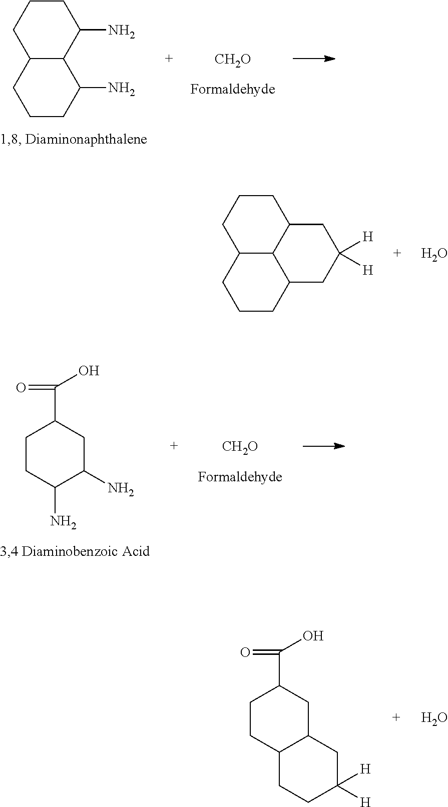

The present invention is further illustrated by means of the following examples.

### EXAMPLES

All VOC tests were performed from injection molded samples having a surface area of 8,000 mm² (80×100 mm with thickness: 3 mm).

The test materials were conditioned for 7 days at temperature 20.0±5° C. and relative humidity 50.0±5% prior VOC testing by a testing facility. After conditioning, the test materials were wrapped in aluminum foil and shipped to the testing facility. No ink, adhesive tape, or absorbing packaging material was used on, or in conjunction with the test samples, as this may have an effect on the results.

The following procedure was performed to measure the VOCs:
1. Bag Preparation
   A suitable air sampling bag made from Tedlar® film was heated in an air-circulating oven at 140° C. for 4 hours.
2. VOC Test
   The test material was placed inside the bag.
   The bag was filled with 4 liters of nitrogen.
   The last step was repeated for a total of three fill and purges.
   Filled the bag with 4 liters of nitrogen.
   Placed the bag in a thermal chamber and heated to 60° C. in 0.5 to 1.0 hours.
   Held temperature at 60° C. for 2.0 hours.
   After two hours, the first 100 ml of sample were drawn and discarded.
   Collecting tubes for volatile organic substances (Tenax and DNPH tubes, this latter used for collecting aldehydes) were sampled while the test part was held at 60° C.
3. Air Sample Analysis
   Connected the Tenax tube to the bag and pulled 1.0 liter from the bag at 100 ml/min through the tube (collection time 10 min).
   Conducted thermal desorbtion of the Tenax-filled tube and analyzed the test material using Gas Chromatograph Mass Spectrometry (GC-MS) (PERKIN ELMER CLARUS™ 600 with ATD-350 Thermal Desorber, Agilent 50 m×0.32 mm, ID 1.0 um df column).
   Connected the DNPH tube to the bag and pulled 2.0 liters from the bag at 1,000 ml/min through the tube (collection time 2 min).
   Conducted High Performance Liquid Chromatography (HPLC) on the DNPH tube (HEWLETT-PACKARD™ 1100, Deltabond AK 250 mm×4 mm column, 20 ul).
4. Test Results
   The test materials were tested along with a blank bag for comparison.

The results are shown in the following examples.

### Comparative Example 1 (CE1)

### TMP-Reinforced PP, No Scavenger

A polypropylene matrix (TOTAL™ 3622) was compounded with (Thermo-Mechanical Pulp, “TMP”) wood fiber, coupling agent (OREVAC® CA) and anti-oxidant (ADD-VANCE® 453) indicated in table 1. The compound was pelletized and molded in an ENGEL™ 200 TL injection molding machine.

The resin and the wood fiber were dried to a final moisture content of 0.1 wt. % prior to compounding and injection molding.

In this example, no liquid additive scavenger was used.

The VOC test was performed after aging the test specimens.

TABLE 1
Preparation of TMP-reinforced polypropylene with no scavenger

| Material | Wt. % |
|---|---|
| Polypropylene | 56 |
| Wood fiber | 40 |
| Coupling Agent | 2 |
| Anti-oxidant | 2 |
| Scavenger | 0 |

TABLE 2
VOCs of CE1

| VOC | μg/m³ |
|---|---|
| Formaldehyde | 61 |
| Acetaldehyde | 177 |
| Acrolein | 0 |
| Benzene | 0 |
| Toluene | 648 |
| Ethyl-benzene | 4 |
| Xylene | 14 |
| Styrene | 121 |
| Para- | 0 |
| dichlorobenzene | |
| Tetradecane | 9 |
| Chlorpyrifos | 0 |
| Di-n-butyl-phthalate | 0 |
| Di-2-ethylhexyl | 0 |
| phthalate | |
| Fenobucarb | 0 |

### Comparative Example 2 (CE2)

### BCTMP-Reinforced PP, No Scavenger

A polypropylene matrix (TOTAL® 3622) was compounded with (Bleached-Chemi-Thermo-Mechanical, “BCTMP”) wood fiber, coupling agent (PRIEX® 20097), primary anti-oxidant (IRGANOX® 1010) and secondary anti-oxidant (IRGANOX® B225) indicated in table 3. The compound was pelletized and molded in an ENGEL® 200 TL injection molding machine.

The resin and the wood fiber were dried to a final moisture content of 0.1 wt. % prior to compounding and injection molding.

In this example, no liquid additive scavenger was used.

The VOC test was performed after aging the test specimens.

TABLE 3
Preparation of BCTMP-reinforced
polypropylene with no scavenger

| Material | Wt. % |
|---|---|
| Polypropylene | 54.2 |
| Wood fiber | 40 |
| Coupling Agent | 5 |
| Primary anti-oxidant | 0.5 |
| Secondary anti-oxidant | 0.3 |
| Scavenger | 0 |

TABLE 4
VOCs of CE2

| VOC | μg/m³ |
|---|---|
| Formaldehyde | 46 |
| Acetaldehyde | 139 |
| Acrolein | 0 |
| Benzene | 1 |
| Toluene | 0 |
| Ethyl-benzene | 0 |
| Xylene | 0 |
| Styrene | 4 |
| Para- | 0 |
| dichlorobenzene | |
| Tetradecane | 2 |
| Chlorpyrifos | 0 |
| Di-n-butyl-phthalate | 0 |
| Di-2-ethylhexyl | 0 |
| phthalate | |
| Fenobucarb | 0 |

### Comparative Example 3 (CE3)

### Kraft-Reinforced PP, No Scavenger

A polypropylene matrix (TOTAL® 3622) was compounded with (unrefined kraft) wood fiber, coupling agent (PRIEX® 20097), primary anti-oxidant (IRGANOX® 1010) and secondary anti-oxidant (IRGANOX® B225) indicated in table 5. The compound was pelletized and molded in an ENGEL® 200 TL injection molding machine.

The resin and the wood fiber were dried to a final moisture content of 0.1 wt. % prior to compounding and injection molding.

In this example, no liquid additive scavenger was used.

The VOC test was performed after aging the test specimens.

TABLE 5
Preparation of Kraft-reinforced polypropylene with no scavenger

| Material | Wt. % |
|---|---|
| Polypropylene | 57.2 |
| Wood fiber | 40 |
| Coupling Agent | 2 |
| Primary anti-oxidant | 0.5 |
| Secondary anti-oxidant | 0.3 |
| Scavenger | 0 |

TABLE 6
VOCs of CE3

| VOC | μg/m³ |
|---|---|
| Formaldehyde | 92 |
| Acetaldehyde | 107 |
| Acrolein | 0 |
| Benzene | 20 |
| Toluene | 48 |
| Ethyl-benzene | 0 |
| Xylene | 2 |
| Styrene | 13 |
| Para- | 0 |
| dichlorobenzene | |
| Tetradecane | 8 |
| Chlorpyrifos | 0 |
| Di-n-butyl-phthalate | 0 |
| Di-2-ethylhexyl | 0 |
| phthalate | |
| Fenobucarb | 0 |

CE1, CE2 and CE3 all have acetaldehyde and formaldehyde content.

### Inventive Example 1 (IE1)

### Kraft-Reinforced PP, Added COLORMATRIX “TRIPLE A”

A polypropylene matrix (TOTAL® 3925) was compounded with (unrefined kraft) wood fiber, coupling agent (PRIEX® 20097), primary anti-oxidant (IRGANOX® 1010) and secondary anti-oxidant (IRGANOX® B225) indicated in table 7. The compound was pelletized and molded in an ENGEL® 200 TL injection molding machine.

The resin and the wood fiber were dried to a final moisture content of 0.1 wt. % prior to compounding and injection molding.

A liquid additive scavenger (COLORMATRIX™ “TRIPLE A”™ LIQUID ADDITIVE indicated in table 7) was used during the molding phase as described in the method disclosed above.

The VOC test was performed after aging the test specimens.

TABLE 7
Preparation of Kraft-reinforced polypropylene with scavenger

| Material | Wt. % |
|---|---|
| Polypropylene | 56.2 |
| Wood fiber | 40 |
| Coupling Agent | 2 |
| Primary anti-oxidant | 0.5 |
| Secondary anti-oxidant | 0.3 |
| Scavenger | 1 |

TABLE 8
VOCs of IE1

| VOC | μg/m³ |
|---|---|
| Formaldehyde | 0 |
| Acetaldehyde | 0 |
| Acrolein | 0 |
| Benzene | 0 |
| Toluene | 0 |
| Ethyl-benzene | 0 |
| Xylene | 3 |
| Styrene | 46 |
| Para- | 0 |
| dichlorobenzene | |
| Tetradecane | 11 |
| Chlorpyrifos | 0 |
| Di-n-butyl-phthalate | 0 |
| Di-2-ethylhexyl | 0 |
| phthalate | |
| Fenobucarb | 0 |

### Inventive Examples 2 and 3 (IE2, IE3)

### Kraft-Reinforced PP, Added COLORMATRIX™ “180-30609-1”

A polypropylene matrix (STYRON™ 7600) was compounded with (unrefined kraft) wood fiber, coupling agent (PRIEX® 20097), primary anti-oxidant (IRGANOX® 1010) and secondary anti-oxidant (IRGANOX® B225) indicated in table 9. The compound was pelletized and molded in an ENGEL® 200 TL injection molding machine.

The resin and the wood fiber were dried to a final moisture content of 0.1 wt. % prior to compounding and injection molding.

A liquid additive scavenger (COLORMATRIX™ “180-30609-1” indicated in table 9) was used during the molding phase as described in the method disclosed above.

The VOC test was performed after aging the test specimens.

TABLE 9
Preparation of Kraft-reinforced polypropylene with scavenger

Replicate

| Material (wt. %) | IE2 | IE3 |
|---|---|---|
| Polypropylene | 58.79 | 58.475 |
| Wood fiber | 33 | 33 |
| Coupling Agent | 5 | 5 |
| Primary anti-oxidant | 1.5 | 1.5 |
| Secondary anti-oxidant | 1.5 | 1.5 |
| Scavenger | 0.21 | 0.525 |

TABLE 10
VOCs of IE2 and IE3

Replicate

| VOC (μg/m³) | IE2 | IE3 |
|---|---|---|
| Formaldehyde | 0 | 0 |
| Acetaldehyde | 0 | 0 |
| Acrolein | 0 | 0 |
| Benzene | 0 | 0 |
| Toluene | 16 | 13 |
| Ethyl-benzene | 9 | 18 |
| Xylene | 0 | 0 |
| Styrene | 0 | 0 |
| Para-dichlorobenzene | 0 | 0 |
| Tetradecane | 89 | 63 |
| Chlorpyrifos | 0 | 0 |
| Di-n-butyl-phthalate | 0 | 0 |
| Di-2-ethylhexyl phthalate | 0 | 0 |
| Fenobucarb | 0 | 0 |

### Inventive Examples 4 and 5 (IE4 and IE5)

### Kraft-Reinforced PP, Added COLORMATRIX™ “180-30610-1”

A polypropylene matrix (STYRON™ 7600) was compounded with (unrefined kraft) wood fiber, coupling agent (PRIEX® 20097), primary anti-oxidant (IRGANOX® 1010) and secondary anti-oxidant (IRGANOX® B225) indicated in table 11. The compound was pelletized and molded in an ENGEL® 200 TL injection molding machine.

The resin and the wood fiber were dried to a final moisture content of 0.1 wt. % prior to compounding and injection molding.

A liquid additive scavenger (COLORMATRIX™ “180-30610-1”, indicated in table 11) was used during the molding phase as described in the method disclosed.

The VOC test was performed after aging the test specimens.

TABLE 11
Preparation of Kraft-reinforced polypropylene with scavenger

Replicate

| Material (wt. %) | IE4 | IE5 |
|---|---|---|
| Polypropylene | 58.79 | 58.475 |
| Wood fiber | 33 | 33 |
| Coupling Agent | 5 | 5 |
| Primary anti-oxidant | 1.5 | 1.5 |
| Secondary anti-oxidant | 1.5 | 1.5 |
| Scavenger | 0.21 | 0.525 |

TABLE 12
VOCs of IE4 and IE5

Replicate

| VOC (μg/m³) | IE4 | IE5 |
|---|---|---|
| Formaldehyde | 0 | 0 |
| Acetaldehyde | 0 | 0 |
| Acrolein | 0 | 0 |
| Benzene | 0 | 0 |
| Toluene | 36 | 27 |
| Ethyl-benzene | 0 | 0 |
| Xylene | 0 | 0 |
| Styrene | 0 | 0 |
| Para-dichlorobenzene | 0 | 0 |
| Tetradecane | 64 | 65 |
| Chlorpyrifos | 0 | 0 |
| Di-n-butyl-phthalate | 0 | 0 |
| Di-2-ethylhexyl phthalate | 0 | 0 |
| Fenobucarb | 0 | 0 |

### Inventive Examples 6 and 7 (IE6, IE7)

### Kraft-Reinforced PP, Added COLORMATRIX™ “180-30611-1”

A polypropylene matrix (STYRON™ 7600) was compounded with (unrefined kraft) wood fiber, coupling agent (PRIEX® 20097), primary anti-oxidant (IRGANOX® 1010) and secondary anti-oxidant (IRGANOX® B225) indicated in table 13. The compound was pelletized and molded in an ENGEL® 200 TL injection molding machine.

The resin and the wood fiber were dried to a final moisture content of 0.1 wt. % prior to compounding and injection molding.

The liquid additive scavenger (COLORMATRIX™ “180-30611-1” indicated in table 13) was used during the molding phase as described in the method disclosed.

The VOC test was performed after aging the test specimens.

TABLE 13
Preparation of Kraft-reinforced polypropylene with scavenger

Replicate

| Material (wt. %) | IE6 | IE7 |
|---|---|---|
| Polypropylene | 58.85 | 58.625 |
| Wood fiber | 33 | 33 |
| Coupling Agent | 5 | 5 |
| Primary anti-oxidant | 1.5 | 1.5 |
| Secondary anti-oxidant | 1.5 | 1.5 |
| Scavenger | 0.15 | 0.375 |

TABLE 14
VOCs of IE6 and IE7

Replicate

| VOC (μg/m³) | IE6 | IE7 |
|---|---|---|
| Formaldehyde | 0 | 0 |
| Acetaldehyde | 0 | 0 |
| Acrolein | 0 | 0 |
| Benzene | 0 | 0 |
| Toluene | 11 | 14 |
| Ethyl-benzene | 0 | 0 |
| Xylene | 0 | 0 |
| Styrene | 0 | 0 |
| Para-dichlorobenzene | 0 | 0 |
| Tetradecane | 18 | 36 |
| Chlorpyrifos | 0 | 0 |
| Di-n-butyl-phthalate | 0 | 0 |
| Di-2-ethylhexyl phthalate | 0 | 0 |
| Fenobucarb | 0 | 0 |

IE1 through IE7 do not have acetaldehyde and formaldehyde content.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of reducing aldehyde emissions during injection molding of a part with a cellulosic fiber-reinforced polypropylene composition comprising the steps of:
providing an injection molding machine capable of the parameters necessary for injection molding of a cellulosic fiber reinforced polypropylene composition, of said injection molding machine including: a hopper for holding of a pelletized cellulosic fiber-reinforced polypropylene composition material: a feed throat portion; and, a mixing chamber installed in line with the injection molding machine between the hopper and the feed throat portion;
metering an effective amount of an aldehyde reducing composition into the mixing chamber containing pelletized cellulosic fiber-reinforced polypropylene composition;
mixing the pelletized cellulosic fiber-reinforced polypropylene composition with the aldehyde reducing composition for wetting the surface of the pellets with the aldehyde reducing composition; and
injection molding of a part with the wetted pelletized mixture.

2. The method of reducing aldehyde emissions during injection molding of a part with a cellulosic fiber-reinforced polypropylene composition of claim 1, wherein said aldehyde reducing composition it selected from the group consisting of an anthranilamide, an anthranilamide derivative, 1,8 diaminonaphthalene, or 3,4-diaminobenzoic acid and mixtures thereof.

3. The method of reducing aldehyde emissions during injection molding of a part with a cellulosic fiber-reinforced polypropylene composition of claim 2, wherein the aldehyde reducing composition is used in the effective amount such that from about 0.15 to 0.525 weight percent of the additive is found in the injection molded composition.

4. The method of reducing aldehyde emissions during injection molding of a part with a cellulosic fiber-reinforced polypropylene composition of claim 1, wherein a peristaltic pump is used for metering of the aldehyde reducing composition into the mixing chamber.

5. The method of reducing aldehyde emissions during injection molding of a part with a cellulosic fiber-reinforced polypropylene composition of claim 4, wherein the peristaltic pump is operably connected to a reservoir containing the aldehyde reducing composition and a hose to deliver the aldehyde reducing composition to the mixing chamber, wherein a control signal is sent to the peristaltic pump to feed the predetermined effective amount of the aldehyde reducing composition during a recovery time of the injection molding cycle.

6. The method of reducing aldehyde emissions during injection molding of a part with a cellulosic fiber-reinforced polypropylene composition of claim 1, wherein the part is an automotive part.

7. The method of reducing aldehyde emissions during injection molding of a part with a cellulosic fiber-reinforced polypropylene composition of claim 6, wherein at least acetaldehyde and formaldehyde content that is generated during the injection molding of the cellulosic fiber-reinforced polypropylene composition is decreased to meet predetermined automotive requirements on volatile organic compounds emissions.

8. The method of reducing aldehyde emissions during injection molding of a part with a cellulosic fiber-reinforced polypropylene composition of claim 7, wherein a plurality of other volatile organic compounds selected from the group consisting of acrolein, benzene, toluene, ethyl-benzene, xylene, styrene, p-dichlorobenzene, tetradecane, chlorpyrifos, di-n-butylpthalate, di-2-ethylhexylphthalate, fenobucarbon and diazinon are at low levels to meet predetermined automotive requirements on volatile organic compounds emissions.

9. The method of reducing aldehyde emissions during injection molding of a part with a cellulosic fiber-reinforced polypropylene composition of claim 1, wherein the effective amount of aldehyde reducing composition is that which binds to at least acetaldehyde and formaldehyde that is generated during the injection molding of the cellulosic fiber-reinforced polypropylene composition to eliminate the release of the acetaldehyde and formaldehyde.

10. A method of reducing aldehyde emissions during injection molding of a part with a cellulosic fiber-reinforced polypropylene composition comprising the steps of:
providing pelletized cellulosic fiber-reinforced polypropylene composition material;
providing an aldehyde reducing composition, said aldehyde reducing composition comprising at least two moieties selected from the group consisting of anthranilamide, anthranilamide derivative, 1,8 diaminonaphthalene, 3,4-diaminobenzoic acid and combinations thereof;
providing an injection molding machine capable of the predetermined parameters necessary for injection molding of the cellulosic fiber-reinforced polypropylene composition, said injection molding machine including a hopper portion for holding the pelletized cellulosic fiber-reinforced polypropylene composition material, a feed throat portion, a mixing chamber installed between the hopper and feed throat portions, and a pump for delivering an effective amount of the aldehyde reducing composition to the mixing chamber;
metering an effective amount of the aldehyde reducing composition into the mixing chamber containing a predetermined amount of the pelletized cellulosic fiber-reinforced polypropylene composition;
operably mixing the pelletized cellulosic fiber-reinforced polypropylene composition with the aldehyde reducing composition for wetting the surface of the pellets with the aldehyde reducing composition; and
injection molding of the part with the wetted pelletized mixture.

11. The method of reducing aldehyde emissions during injection molding of a part with a cellulosic fiber-reinforced polypropylene composition of claim 10, wherein the pump is a peristaltic pump.

12. The method of reducing aldehyde emissions during injection molding of a part with a cellulosic fiber-reinforced polypropylene composition of claim 11, wherein the peristaltic pump is operably connected to a reservoir containing the aldehyde reducing composition and a hose to deliver the aldehyde reducing composition to the mixing chamber, wherein a control signal is sent to the peristaltic pump to feed the predetermined effective amount of the aldehyde reducing composition during a recovery time of the injection molding cycle.

13. The method of reducing aldehyde emissions during injection molding of a part with a cellulosic fiber-reinforced polypropylene composition of claim 10, wherein the aldehyde reducing composition is used in an effective amount such that about 0.15 to 0.525 weight percent of the additive is found in the injection molded composition.

14. The method of reducing aldehyde emissions during injection molding of a part with a cellulosic fiber-reinforced polypropylene composition of claim 13, wherein the effective amount is about 0.21 to 0.525 weight percent.

15. The method of reducing aldehyde emissions during injection molding of a part with a cellulosic fiber-reinforced polypropylene composition of claim 13, wherein the effective amount is about 0.15 to 0.375 weight percent.

16. The method of reducing aldehyde emissions during injection molding of a part with a cellulosic fiber-reinforced polypropylene composition of claim 10, wherein the polypropylene composition is reinforced with vegetal fibers selected from the group consisting of hardwoods, softwoods, roots, husks, fruits, seeds, grasses, reeds, basts, stalks, canes, leafs, leaf sheaths and combinations thereof.

17. The method of reducing aldehyde emissions during injection molding of a part with a cellulosic fiber-reinforced polypropylene composition of claim 10, wherein the method decreases at least acetaldehyde and formaldehyde content in the cellulosic fiber-reinforced polypropylene composition to meet predetermined requirements.

18. The method of reducing aldehyde emissions during injection molding of a part with a cellulosic fiber-reinforced polypropylene composition of claim 17, wherein the method allows a plurality of other volatile organic compounds to be at low levels to meet predetermined requirements, said other volatile organic compounds selected from the group consisting of acrolein, benzene, toluene, ethyl-benzene, xylene, styrene, p-dichlorobenzene, tetradecane, chlorpyrifos, di-n-butylpthalate, di-2-ethylhexylphthalate, fenobucarbon and diazinon.

19. A method of reducing aldehyde emissions during injection molding of a part with a cellulosic fiber-reinforced polypropylene composition comprising the steps of:
providing pelletized cellulosic fiber-reinforced polypropylene composition material;
providing an aldehyde reducing composition, said aldehyde reducing composition comprising at least two moieties selected from the group consisting of anthranilamide, anthranilamide derivative, 1,8 diaminonaphthalene, 3,4-diaminobenzoic acid and combinations thereof;
providing an injection molding machine capable of the predetermined parameters necessary for injection molding of the cellulosic fiber-reinforced polypropylene composition, said injection molding machine including a barrel for injection molding, a hopper portion for holding the pelletized cellulosic fiber-reinforced polypropylene composition material, a feed throat portion, a mixing chamber installed between the hopper and feed throat portions, and a peristaltic pump for delivering an effective amount of the aldehyde reducing composition to the mixing chamber;
metering the effective amount of the aldehyde reducing composition into the mixing chamber containing a predetermined amount of the pelletized cellulosic fiber-reinforced polypropylene composition during a recovery time of the injection molding cycle;
operably mixing the pelletized cellulosic fiber-reinforced polypropylene composition with the aldehyde reducing composition for wetting the surface of the pellets with the aldehyde reducing composition; and
injection molding of the part with the wetted pelletized mixture;
wherein at least acetaldehyde and formaldehyde emissions are reduced to predetermined levels meeting requirements.

20. The method of reducing aldehyde emissions during injection molding of a part with a cellulosic fiber-reinforced polypropylene composition of claim 16, wherein the aldehyde reducing composition is used in an effective amount such that from about 0.15 and 0.525 weight percent of the additive is found in the injection molded composition.
